(19) United States
(12) Patent Application Publication
(10) Pub. No.: US 2025/0319749 A1
(43) Pub. Date: Oct. 16, 2025

(54) VECTOR AIR OUTLET AND MOTOR VEHICLE

(71) Applicant: Volkswagen Aktiengesellschaft, Wolfsburg (DE)

(72) Inventors: Eike BOETTCHER, Wolfsburg (DE); Mirko ALT, Wolfsburg (DE); Cornelia SCHEEL, Wolfsburg (DE); Christoph THOMSCHKE, Wolfsburg (DE)

(73) Assignee: Volkswagen Aktiengesellschaft, Wolfsburg (DE)

(21) Appl. No.: 19/180,647

(22) Filed: Apr. 16, 2025

(30) Foreign Application Priority Data
Apr. 16, 2024 (DE) 10 2024 203 511.4

(51) Int. Cl. B60H 1/34

(52) U.S. Cl. CPC B60H 1/3428; B60H 2001/3478

(57) ABSTRACT

A vector air outlet for a ventilation system for a motor vehicle, including an air outlet housing through which an air channel having a channel inlet and a channel outlet is formed. A horizontally formed channel partition wall divides the air channel into a first subchannel and a second subchannel. A control valve arranged upstream from the channel partition wall in the flow direction, is pivotable around a first pivot axis formed transversely to the flow direction. A plurality of deflecting louvers are arranged in the first subchannel and the second subchannel and are held on the air outlet housing pivotable around a second pivot axis formed transversely to the first pivot axis in the flow direction. The deflecting louvers have a longitudinal extension in the flow direction from a louver head region via a louver intermediate region to a louver foot region.

This nonprovisional application claims priority under 35 U.S.C. § 119(a) to German Patent Application No. 10 2024 203 511.4, which was filed in Germany on Apr. 16, 2024, and which is herein incorporated by reference.

### BACKGROUND OF THE INVENTION

### Field of the Invention

The present invention relates to a vector air outlet for a ventilation system for a motor vehicle. The invention furthermore relates to a motor vehicle, including a ventilation system, which has a vector air outlet.

### Description of the Background Art

Ventilation systems for motor vehicles are known, which include an air outlet for discharging air into a passenger cell. Conventional air outlets include an air outlet housing, through which an air channel is formed, which has a channel inlet and a channel outlet. One or multiple vertically pivotable air guiding louvers is/are arranged in the air channel for diverting the air flow to the left or right into the passenger cell, as well as one or multiple horizontally pivotable air guiding louvers for diverting the air flow upwardly or downwardly into the passenger cell. The horizontally pivotable air guiding louvers may be mechanically coupled to each other, for example for the purpose of joint pivoting. The vertically pivotable air guiding louvers may likewise be mechanically coupled to each other for the purpose of joint pivoting.

The vector air outlet is a special type of air outlet. While the vertical diversion of the air flow in a conventional air outlet takes place directly via the air guiding louvers, the vertical diversion of the air flow in vector air outlets takes place via two air flows arranged one above the other. For this purpose, vector air outlets have a channel partition wall in the air channel, by means of which the air channel is divided into an upper subchannel and a lower subchannel. To control an air volume ratio and thus a flow distribution in the upper subchannel and the lower subchannel, a control valve is arranged upstream from the channel partition wall in the flow direction.

The document FR 3 054 491 B1 shows a vector air outlet, which has a plurality of deflecting louvers, which are supported on an air outlet housing, such that they are pivotable, approximately centrally, around a pivot axis in the flow direction. A vector air outlet is known from the document JP 73 94 541 B2, in which no deflecting louvers are provided. The air channel is divided by channel partition walls into an upper subchannel, a central subchannel, and a lower subchannel. The deflection of the air flow takes place solely by distributing the air flow into the air subchannels via a control valve. An alternative ventilation air outlet is known from the document DE 10 2021 118 937 A1.

Known ventilation air outlets have the disadvantage that the deflecting louvers sometimes project into an outflow region of the ventilation air outlet and are thus arranged within a viewing area of the ventilation air outlet, which is visible to a passenger in the passenger cell of the motor vehicle. Moreover, ventilation air outlets often have comparatively large dimensions for discharging a predefined air flow, which often conflict with design inputs of vehicle cockpits.

### SUMMARY OF THE INVENTION

It is therefore an object of the present invention is therefore to at least partially eliminate the disadvantages described above in a ventilation air outlet. The object of the present invention is, in particular, to provide a ventilation air outlet and a motor vehicle including a ventilation system, which easily and cost-effectively provide a greater ratio between the air flow and installation space and/or an improved lamination of the deflecting louvers.

Features and details which are described in connection with the vector air outlet according to the invention also apply, of course, in connection with the motor vehicle according to the invention and vice versa in each case, so that reference always is or may be made interchangeably with respect to the disclosure of the individual aspects of the invention.

According to a first aspect of the invention, the object is achieved by a vector air outlet for a ventilation system for a motor vehicle. The vector air outlet includes an air outlet housing, through which an air channel having a channel inlet and a channel outlet is formed, a horizontally formed channel partition wall, which divides the air channel into a first subchannel and a second subchannel, a control valve, which is arranged upstream from the channel partition wall in the flow direction and is pivotable around a first pivot axis formed transversely to the flow direction, and a plurality of deflecting louvers, which are arranged in the first subchannel and second subchannel and are each held on the air outlet housing, pivotable around a second pivot axis formed in the flow direction as well as transversely to the first pivot axis. The deflecting louvers have a longitudinal extension in the flow direction from a louver head region via a louver intermediate region to a louver foot region. According to the invention, the second pivot axes are each arranged in the louver foot region, the louver foot region comprising less than 20% of the longitudinal extension of the deflecting louver.

A flow direction can be understood to be the direction of the undeflected air flow, for example when the control valve and the deflecting louvers are each arranged in a neutral position.

The air channel can be formed by the air outlet housing. The air channel has the channel inlet for introducing an air flow for ventilating a passenger cell of the motor vehicle and the channel outlet for discharging the air flow in a targeted manner out of the air channel into the passenger cell. The air channel may have, for example, different air channel widths and/or different air channel heights in the flow direction. It may be provided according to the invention that the air channel has a uniform cross-sectional shape or changed cross-sectional shapes in the flow direction. The cross-sectional shape of the air channel can be rectangular or at least essentially rectangular. It is preferred that the air channel width is greater than the air channel height.

The air outlet housing may, for example, be manufactured from a plastic or include a plastic. The air outlet housing may be provided with a one-part or multi-part design, for example made up of a first housing half and a second housing half. The air outlet housing may furthermore include a metal, for example in the region of the channel outlet, such as aluminum or the like, which may surround the channel outlet. The channel outlet may be designed, for example according to a nozzle or a diffuser. Air may be introduced into a passenger cell of the motor vehicle from the air channel via the channel outlet. The channel outlet is thus within visual range of occupants of the motor vehicle.

A channel partition wall can be arranged in the air channel. The air channel is divided by the channel partition wall into the first air channel and the second air channel. The first air channel can be designed as an upper air channel, and the second air channel can be designed as a lower air channel. Alternatively, the first air channel may be designed as a right air channel and the second air channel as a left air channel. The channel partition wall may include, for example, a double wall having a first wall for limiting the first air channel and a second wall for limiting the second air channel, a free space can be formed between the first wall and the second wall. The deflecting louvers can be pivotably supported in the free space, for example between the first wall and the second wall. The first wall and the second wall further can extend from a shared contact region in the flow direction as well as away from each other. The first wall can be designed to be monolithic with the second wall. A cross-section of the channel wall may be provided, for example, with a U-shaped, V-shaped, or similar design, the shanks of the channel wall being formed by the first wall and the second wall. It may be provided according to the invention that the channel partition wall is formed monolithically with the air outlet housing or a part of the air outlet housing, for example a first housing half or a second housing half. Alternatively, a first part of the channel partition wall may also be formed monolithically with the first housing half and a second part of the channel partition wall with the second housing half. In this case, the channel partition wall may thus be provided with a multi-part design. The channel partition wall may end upstream from the channel outlet in the flow direction, so that the air flows of the first subchannel and the second subchannel converge again within the vector air outlet.

The control valve can be arranged upstream from the channel partition wall in the flow direction. This means that an air flow passing through the vector air outlet reaches the control valve first and then the channel partition wall. Within the scope of the invention, the flow direction of the air channel is understood to be the direction of an air flow which is not deflected by the control valve or the deflecting louvers. The control valve can be arranged in alignment with the channel partition wall. The control valve is designed to be pivotable around the first pivot axis. The first pivot axis can be arranged in parallel to a surface, on which the channel partition wall extends. The first pivot axis can be arranged directly adjacent to the channel partition wall, so that a deflectable first end of the control valve is oriented against the flow direction, and a second end of the control valve opposite the first end is arranged directly at the first pivot axis.

The control valve can be designed to distribute the air flow passing through the air channel to the first subchannel and the second subchannel. The control valve is designed, for example, to uniformly distribute the air flow to the first subchannel and the second subchannel in a neutral position. The control valve can be designed to cover the second subchannel in a first extreme position, so that the entire air flow passing through the air channel is guided into the first subchannel. The control valve can be designed to cover the first subchannel in a second extreme position, so that the entire air flow passing through the air channel is guided into the second subchannel.

The deflecting louvers can be arranged downstream from the control valve in the flow direction. The deflecting louvers can be arranged in the air outlet housing in such a way that the second pivot axes are arranged next to each other in an evenly distributed manner, so that the deflecting louvers are also arranged next to each other in an evenly distributed manner. The deflecting louvers can be mechanically coupled with each other via a connecting brace in such a way that all deflecting louvers are deflectable, for example, uniformly deflectable, by moving the connecting brace. The second pivot axes are formed transversely to the first pivot axis. The second pivot axes can be arranged on a common plane. The first pivot axis is arranged in parallel to the plane of the second pivot axes. The flow direction can be perpendicular to this plane. The deflecting louvers may be held on the air outlet housing directly or indirectly, for example via a bearing strip or the like.

The deflecting louvers have the louver head region, the louver intermediate region, and the louver foot region, the louver head region being oriented against the flow direction in a neutral position of the deflecting louvers. The louver foot region is arranged downstream from the louver intermediate region in the flow direction. The louver intermediate region is arranged downstream from the louver head region in the flow direction. According to the invention, the second pivot axes run through the louver foot region, the louver foot region comprising less than 20% of the longitudinal extension of the deflecting louver. The louver intermediate region and the louver head region thus together comprise more than 80% of the longitudinal extension of the deflecting louver. The second pivot axis may run through the louver head region, for example, directly next to the louver intermediate region. Alternatively, the second pivot axis may also run through the louver head region farther away from the louver intermediate region. As a result, the deflecting louvers are supported on the air outlet housing in a greatly eccentric manner. The deflecting louvers thus differ essentially from the known deflecting louvers, in which the second pivot axes run approximately through the middle of the louver intermediate region.

An actuating device can be provided for the targeted pivoting of the control valve and/or the deflecting louvers. The actuating device can be held on the channel partition wall and is mechanically coupled with the control valve and/or the deflecting louvers.

A vector air outlet according to the invention can have the advantage over conventional vector air outlets that a predefined great deflection of the air flow may be effectuated, using simple means as well as in a cost-effective manner with reduced dimensions, so that the ratio of maximum deflection to installation space demand is considerably increased compared to conventional vector air outlets. Due to the eccentric support of the deflecting louvers, the outer deflecting louvers may be arranged closer to the housing wall of the air outlet housing. Moreover, the deflecting louvers may be arranged farther inside the air outlet housing against the flow direction than centrally supported deflecting louvers, due to the great eccentric support in the louver foot region, so that the deflecting louvers of the vector air outlet according to the invention are brought farther out of the visual range of the occupants of the passenger cell.

According to an example, it may be provided in a vector air outlet that the louver foot region comprises 5% of the longitudinal extension of the deflecting louver. As a result, the louver intermediate region and the louver head region together comprise 95% of the longitudinal extension of the deflecting louver. The deflecting louvers are thus supported particularly greatly eccentrically on the air outlet housing and consequently differ particularly significantly from known deflecting louvers, in which the second pivot axis runs approximately through the center of the louver intermediate region. This has the advantage that a particularly advantageous deflection of the air flow may be effectuated, using simple means as well as in a cost-effective manner with a reduced installation space demand. The deflecting louvers are also brought farther out of the visual range.

The louver foot regions of the outer deflecting louvers can be arranged in alignment with a housing wall of the air outlet housing at the channel outlet. This can be understood to mean that the louver foot regions can be arranged adjacent to the channel outlet, the housing wall arranged in alignment with the louver foot regions extending to the channel outlet or forming the channel outlet. The louver foot regions can be arranged at a distance from the channel outlet, so that the deflecting louvers are less clearly visible from the passenger cell. It is furthermore preferred that the outer deflecting louvers can be arranged on the air outlet housing in such a way that the air flow may be conducted onward directly from the outer louver onto an inside of the housing wall, thus avoiding eddies. This has the advantage that a particularly low-noise operation of the vector air outlet is ensured, using simple means as well as in a cost-effective manner. The outer deflecting louvers can also be at least partially concealed in this way by the housing wall and are thus less visible or not visible at all from the passenger cell.

The air channel can also have a tapering in the width direction and/or the height direction in the region of the deflecting louvers in the flow direction. The tapering of the air channel can be formed at a height between the louver head region and the louver foot region in the flow direction. The tapering can be formed transversely to the second pivot axis, so that the housing wall runs in the direction of a main surface of the deflecting louvers in the region of the tapering. In the case of a perpendicular second pivot axis, the tapering thus runs in the width direction of the vector air outlet. The first tapering can be partially formed by a corresponding design of the housing wall. This has the advantage that a particularly advantageous deflection of the air flow may be effectuated, using simple means as well as in a cost-effective manner with a reduced installation space demand.

The air channel can have a first widening in the width direction and/or the height direction in a region upstream from the deflecting louvers in the flow direction. The first widening of the air channel can be formed at a height between a central region of the control valve and the louver head region in the flow direction. The first widening can be formed transversely to the second pivot axis, so that the housing wall runs in a direction away from a main surface of the deflecting louvers in the region of the first widening. In the case of a perpendicular second pivot axis, the first widening thus runs in the width direction of the vector air outlet. It may be provided according to the invention that the first widening runs in parallel to the direction of the second pivot axis and thus in the height direction of the deflecting louvers. In the case of a perpendicular second pivot axis, the first widening thus runs in the height direction of the vector air outlet. The first widening can be partially formed by a corresponding design of the housing wall. This has the advantage that a particularly advantageous deflection of the air flow may be effectuated, using simple means as well as in a cost-effective manner with a reduced installation space demand.

The air channel can have a second widening in the width direction and/or the height direction in a region downstream from the deflecting louvers in the flow direction. The second widening of the air channel can be formed at a height between the louver foot region and the channel outlet in the flow direction. The second widening can be formed transversely to the second pivot axis, so that the housing wall runs in a direction away from a main surface of the deflecting louvers in the region of the second widening. In the case of a perpendicular second pivot axis, the second widening thus runs in the width direction of the vector air outlet. Alternatively or additionally, it may also be provided that the air channel has a second tapering in the width direction and/or the height direction in the region following the deflecting louvers in the flow direction. The air channel may thus have the second widening in the width direction and the second tapering in the height direction. The second widening and/or the second tapering can be partially formed by a corresponding design of the housing wall. This has the advantage that a particularly advantageous deflection of the air flow may be effectuated, using simple means as well as in a cost-effective manner with a reduced installation space demand.

The deflecting louvers can have a first louver region, a second louver region, and a connecting region, via which the first louver region is mechanically coupled with the second louver region, the first louver region being arranged in the first subchannel, the second louver region in the second subchannel, and the connecting region in the region of the channel partition wall. The second pivot axis extends through the first louver region, the connecting region, and the second louver region. The connecting region can be formed coaxially to the second pivot axis. The connecting region can have an eccentric section. The eccentric sections of the deflecting louvers can be coupled with each other via a connecting rod at a point at a distance from the second pivot axis, so that a uniform, joint pivoting of the deflecting louvers is ensured. This has the advantage that a particularly advantageous deflection of the air flow may be effectuated, using simple means as well as in a cost-effective manner with a reduced installation space demand.

The deflecting louvers may have an enlargement in parallel to the second pivot axis from the louver head region to the louver foot region. In other words, the deflecting louvers can be designed in such a way that a louver base surface increases toward the second pivot axis in the flow direction. This has the advantage that a particularly advantageous deflection of the air flow may be effectuated, using simple means as well as in a cost-effective manner with a reduced installation space demand.

It is preferred according to the invention that the deflecting louvers are pivotably arranged on the air outlet housing in such a way that the first subchannel and/or the second subchannel is/are closed by the deflecting louvers. The deflecting louvers can be pivotably arranged on the air outlet housing in such a way that the first subchannel and the second subchannel are closed simultaneously in a closure position of the deflecting louvers. The closure position can be an extreme pivoted position of the deflecting louvers in a first pivoting direction. In this position, the outer deflecting louver can abut the housing wall. Adjacent deflecting louvers are arranged so as to overlap each other in this extremely pivoted position. The deflecting louvers can be designed in such a way that a closure of the first subchannel and the second subchannel by the deflecting louvers may not be effectuated during a pivoting of the deflecting louvers in a second pivoting direction. This can be ensured in a form-fitting manner by a corresponding design of the housing wall. This has the advantage that a particularly advantageous blocking of the air flow may be effectuated, using simple means as well as in a cost-effective manner with a reduced installation space demand, so that individual vector air outlets may be blocked in a targeted manner, for example when using multiple air outlets.

According to a second aspect of the invention, the object is achieved by a motor vehicle. The motor vehicle can include a ventilation system for ventilating a passenger cell of the motor vehicle. According to the invention, the ventilation system includes a vector air outlet according to the invention for discharging air into the passenger cell.

The ventilation system can include multiple vector air outlets, in particular two, three, or four vector air outlets. The vector air outlet is arranged at an air output of a supply channel of the ventilation system. An air flow provided via the supply channel may be conducted into the air channel of the vector air outlet and into the passenger cell via the channel outlet of the vector air outlet. A flow direction of the air flow may be changed in a targeted manner via the vector air outlet, for example, in a horizontal direction and/or a vertical direction.

In the case of the motor vehicle according to the invention, all advantages result which have already been described in connection with a vector air outlet according to the first aspect of the invention. The motor vehicle according to the invention therefore has the advantage over conventional motor vehicles that a predefined substantial deflection of the air flow may be effectuated, using simple means as well as in a cost- effective manner with reduced dimensions, so that the ratio of maximum deflection to installation space demand is considerably increased compared to conventional vector air outlets. Due to the eccentric support of the deflecting louvers, the outer deflecting louvers may be arranged closer to the housing wall of the air outlet housing. Moreover, the deflecting louvers may be arranged farther inside the air outlet housing against the flow direction than centrally supported deflecting louvers, due to the great eccentric support in the louver foot region, so that the deflecting louvers of the vector air outlet according to the invention are brought farther out of the visual range of the occupants of the passenger cell.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a vector air outlet according to the prior art in a sectional representation from the side;

FIG. 2 schematically shows a vector air outlet according to an example of the invention in a sectional representation from the side;

FIG. 3 schematically shows a vector air outlet according to an example of the invention in a sectional representation from the side;

FIG. 4 schematically shows the vector air outlet from FIG. 3 in a sectional representation from above in a first configuration;

FIG. 5 schematically shows the vector air outlet from FIG. 3 in a sectional representation from above in a second configuration;

FIG. 6 schematically shows the vector air outlet from FIG. 3 in a sectional representation from above in a third configuration;

FIG. 7 schematically shows the vector air outlet from FIG. 3 in a sectional representation from above in a fourth configuration; and

FIG. 8 schematically shows a side view of an example of a motor vehicle according to the invention.

### DETAILED DESCRIPTION

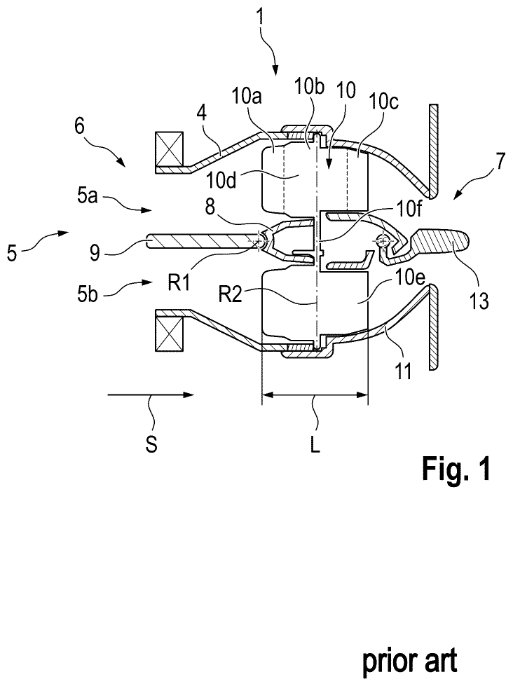

A vector air outlet 1 according to the prior art is illustrated schematically in FIG. 1 in a sectional representation from the side. Vector air outlet 1 includes an air outlet housing 4 having a housing wall 11, through which an air channel 5 is formed, which has a channel inlet 6 and a channel outlet 7. A channel partition wall 8 is arranged in air channel 5, which has an approximately V-shaped cross-section. Air channel 5 is divided by channel partition wall 8 into an upper first subchannel 5a and a lower second subchannel 5b. A control valve 9, which is pivotable around a first pivot axis R1, is arranged in air channel 5 for the purpose of distributing an air flow passing through air channel 5 to first subchannel 5a and second subchannel 5b. First pivot axis R1 is arranged directly on channel partition wall 8.

Multiple deflecting louvers 10 are arranged on air outlet housing 4 downstream from control valve 9 in flow direction S, of which only one front deflecting louver 10 being apparent in this view, by means of which rear deflecting louvers 10 are covered. Deflecting louver 10 has a longitudinal extension L in flow direction S, including a louver head region 10a, a louver intermediate region 10b, and a louver foot region 10c. Deflecting louver 10 is held on air outlet housing 4, pivotable around a second pivot axis R2, which extends through louver intermediate region 10b in the middle of deflecting louver 10.

A first louver region 10d of deflecting louver 10 is arranged in first subchannel 5a, and a second louver region 10e of deflecting louver 10 is arranged in second subchannel 5b. First louver region 10d is connected to second louver region 10e via a connecting region 10f. Connecting region 10f extends coaxially to second pivot axis R2. An actuating device 13 is pivotably held on channel partition wall 8 in the region of channel outlet 7 for the purpose of targeted pivoting of control valve 9 and deflecting louvers 10. Louver foot region 10c of deflecting louver 10 projects into channel outlet 7 to such an extent that air outlet housing 4 must have comparatively large dimensions to ensure a pivoting of deflecting louvers 10.

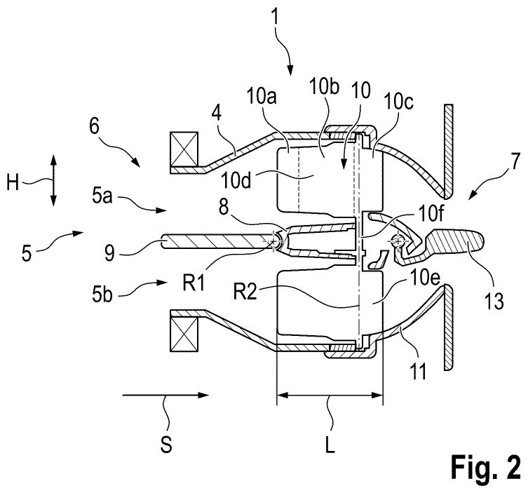

FIG. 2 schematically shows a vector air outlet 1 according to a preferred first specific embodiment of the invention in a sectional representation from the side. Vector air outlet 1 includes an air outlet housing 4 having a housing wall 11, through which an air channel 5 is formed, which has a channel inlet 6 and a channel outlet 7. A channel partition wall 8 is arranged in air channel 5, which has an approximately V-shaped cross-section. Air channel 5 is divided by channel partition wall 8 into an upper first subchannel 5a and a lower second subchannel 5b. A control valve 9, which is pivotable around a first pivot axis R1, is arranged in air channel 5 for the purpose of distributing an air flow passing through air channel 5 to first subchannel 5a and second subchannel 5b. First pivot axis R1 is arranged directly on channel partition wall 8.

Multiple deflecting louvers 10 are arranged on air outlet housing 4 downstream from control valve 9 in flow direction S, of which only one front deflecting louver 10 being apparent in this view, by means of which rear deflecting louvers 10 are covered. Deflecting louver 10 has a longitudinal extension L in flow direction S, including a louver head region 10a, a louver intermediate region 10b, and a louver foot region 10c. Deflecting louver 10 is held on air outlet housing 4, pivotable around a second pivot axis R2, which extends through louver foot region 10c, which has approximately 20% of a total length of deflecting louver 10, as well as louver intermediate region 10c directly adjacent thereto.

A first louver region 10d of deflecting louver 10 is arranged in first subchannel 5a, and a second louver region 10e of deflecting louver 10 is arranged in second subchannel 5b. First louver region 10d is connected to second louver region 10e via a connecting region 10f. Connecting region 10f extends coaxially to second pivot axis R2. An actuating device 13 is pivotably held on channel partition wall 8 in the region of channel outlet 7 for the purpose of targeted pivoting of control valve 9 and deflecting louvers 10. Due to the arrangement of second pivot axis R2 in louver foot region 10c, a distance between louver foot region 10c and channel outlet 7 is reduced compared to the prior art, so that the dimensions of air outlet housing 4 according to the invention are significantly reduced in the region of channel outlet 7.

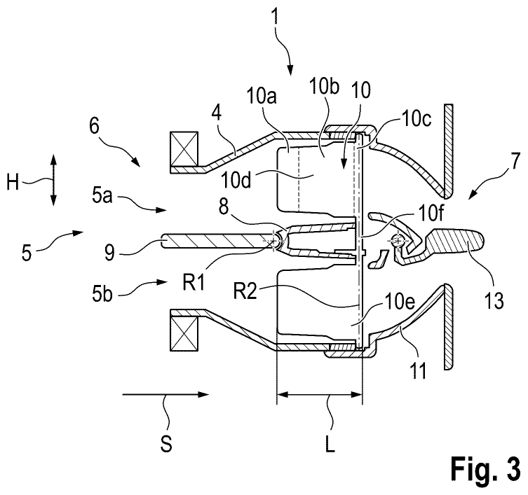

A vector air outlet 1 according to a preferred first specific embodiment of the invention is schematically illustrated in FIG. 3 in a sectional representation from the side. Vector air outlet 1 according to the preferred second specific embodiment of the invention differs from vector air outlet 1 according to the preferred first specific embodiment of the invention in a design and arrangement of deflecting louvers 10. In this exemplary embodiment, louver foot region 10c has approximately 5% of the total length of deflecting louver 10. The distance between louver foot region 10c and channel outlet 7 is thus further reduced. This allows the dimensions of air outlet housing 4 to be further decreased in the region of channel outlet 7.

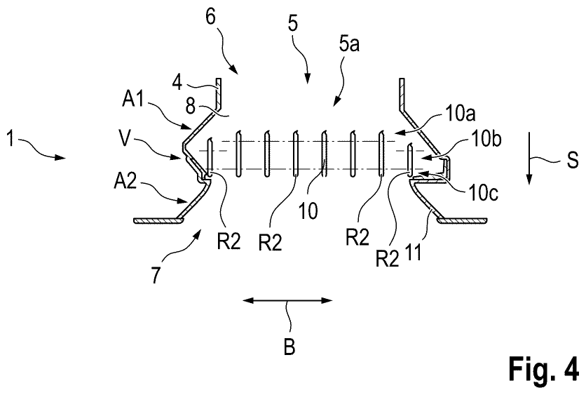

FIG. 4 schematically shows vector air outlet 1 from FIG. 3 in a first configuration in a sectional representation from above. First subchannel 5a of air channel 5 is apparent in this view. Second subchannel 5b is covered by channel partition wall 8. Control valve 9 is not illustrated. It is apparent in this view that, due to the design of housing wall 11 of air outlet housing 4, air channel 5 initially has a first widening A1 in width direction B up to a central region of deflecting louvers 10 upstream from deflecting louvers 10 in flow direction S, then has a tapering V in width direction B up to second pivot axes R2 of deflecting louvers 10, and finally has a second widening A2 in width direction B up to channel outlet 7. Outer deflecting louvers 10 are arranged in alignment with housing wall 11 in flow direction S. In the illustrated first configuration, deflecting louvers 10 are arranged in parallel to flow direction S. The air flow is thus not deflected by deflecting louvers 10.

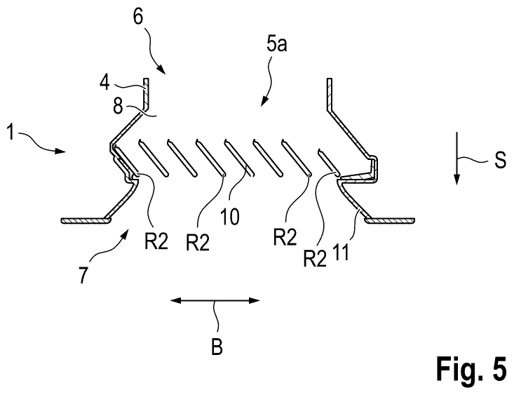

FIG. 5 schematically shows vector air outlet 1 from FIG. 3 in a second configuration in a sectional representation from above. In the second configuration, deflecting louvers 10 are pivoted counterclockwise to the maximum extent around second pivot axis R2, so that outer deflecting louver 10 abuts housing wall 11 of air outlet housing 4. The air flow is thus deflected to the right by deflecting louvers 10.

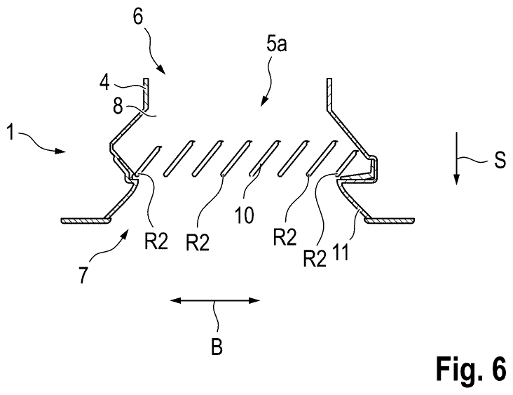

FIG. 6 schematically shows vector air outlet 1 from FIG. 3 in a third configuration in a sectional representation from above. In the third configuration, deflecting louvers 10 are pivoted clockwise around second pivot axis R2 in such a way that the air flow is deflected in the other direction, i.e., to the left, at approximately the same angle as in the second configuration illustrated in FIG. 5. Due to the asymmetrical design of housing wall 11, outer deflecting louver 10 in the third configuration does not abut housing wall 11 of air outlet housing 4.

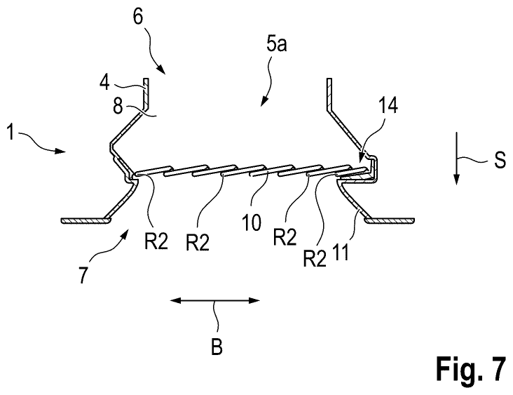

FIG. 7 schematically shows vector air outlet 1 from FIG. 3 in a fourth configuration in a sectional representation from above. In the fourth configuration, deflecting louvers 10 are pivoted clockwise to the maximum extent around second pivot axis R2, so that outer deflecting louver 10 is arranged in a receiving pocket 14 of housing wall 11 of air outlet housing 4. Deflecting louvers 10 are also arranged so as to overlap each other, so that air channel 5 is closed by deflecting louvers 10.

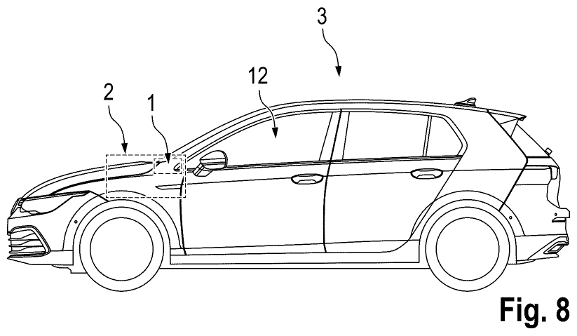

FIG. 8 schematically shows a side view of one preferred specific embodiment of a motor vehicle 3 according to the invention. Motor vehicle 3 includes a ventilation system 2 having a vector air outlet 1 according to the invention. Air may be introduced in a directed manner into a passenger cell 12 of motor vehicle 3 via vector air outlet 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vector air outlet for a ventilation system for a motor vehicle, the vector air outlet comprising:
an air outlet housing through which an air channel having a channel inlet and a channel outlet is formed;
a horizontally formed channel partition wall, which divides the air channel into a first subchannel and a second subchannel;
a control valve arranged upstream from the channel partition wall in a flow direction, the control valve being pivotable around a first pivot axis formed transversely to the flow direction; and
at least two deflecting louvers arranged in the first subchannel and the second subchannel and are held on the air outlet housing pivotable around a second pivot axis formed transversely to the first pivot axis in the flow direction, the deflecting louvers having a longitudinal extension in the flow direction from a louver head region via a louver intermediate region to a louver foot region,
wherein the second pivot axes are each arranged in the louver foot region, and
wherein the louver foot region comprises less than 20% of the longitudinal extension of the deflecting louver.

2. The vector air outlet according to claim 1, wherein the louver foot region comprises 5% of the longitudinal extension of the deflecting louver.

3. The vector air outlet according to claim 1, wherein the louver foot regions of the outer deflecting louvers are arranged in alignment with a housing wall of the air outlet housing at the channel outlet.

4. The vector air outlet according to claim 1, wherein the air channel has a tapering in a width direction and/or a height direction in a region of the deflecting louvers in the flow direction.

5. The vector air outlet according to claim 1, wherein the air channel has a first widening in a width direction and/or a height direction in a region upstream from the deflecting louvers in the flow direction.

6. The vector air outlet according to claim 1, wherein the air channel has a second widening in a width direction and/or a height direction in a region downstream from the deflecting louvers in the flow direction.

7. The vector air outlet according to claim 1, wherein the deflecting louvers have a first louver region, a second louver region, and a connecting region, via which the first louver region is mechanically coupled with the second louver region, wherein the first louver region is arranged in the first subchannel, wherein the second louver region is arranged in the second subchannel, and wherein the connecting region is arranged in the region of the channel partition wall.

8. The vector air outlet according to claim 1, wherein the deflecting louvers have an enlargement in parallel to the second pivot axis from the louver head region to the louver foot region.

9. The vector air outlet according to claim 1, wherein the deflecting louvers are pivotably arranged on the air outlet housing such that the first subchannel and/or the second subchannel are closed by the deflecting louvers.

10. A motor vehicle comprising:
a ventilation system for ventilating a passenger cell of the motor vehicle, the ventilation system comprising the vector air outlet according to claim 1 for discharging air into the passenger cell.
